(19) United States
(12) Patent Application Publication
(10) Pub. No.: US 2016/0049901 A1
(43) Pub. Date: Feb. 18, 2016

(54) PHOTOVOLTAIC SYSTEM

(71) Applicant: SST HOLDING GMBH, Nenzing (AT)

(72) Inventors: Mathias Muther, Röns (AT); Renan Sen, Nenzing (AT)

(73) Assignee: SST HOLDING GMBH, Nenzing (AT)

(21) Appl. No.: 14/652,575

(22) PCT Filed: Dec. 19, 2013
(86) PCT No.: PCT/EP2013/077435

§ 371 Date: Sep. 22, 2015

(30) Foreign Application Priority Data
Dec. 19, 2012 (EP) 12198275.5

(51) Int. Cl. H02S 20/23; H02S 30/10

(52) U.S. Cl. CPC H02S 20/23; H02S 30/10

(57) ABSTRACT

A photovoltaic system (1) comprising at least one photovoltaic module (100) and a support (10) for supporting and/or retaining each photovoltaic module (100) in a position relative to an assembly plane, the position forming an inclination angle. The support (10) comprises first and second engaging elements (20 or 30) for each of the photovoltaic modules (100), each of the engaging elements engaging onto a frame portion (102) of the corresponding photovoltaic module (100). The first engaging element (20), the photovoltaic module (100), and the second engaging element (30) are arranged in a successive manner in a direction (R) of extension, and the mechanical connection between the first and the second engaging elements (20 or 30) in the direction (R) of extension is produced solely by a portion (104) of the photovoltaic module (100), in particular a frame portion (102) of the photovoltaic module (100). The support is paired with air and/or wind conducting apparatus (62) such that a vacuum is generated in an intermediate space formed between at least one of the photovoltaic modules and the underlying assembly plane in the event of an airflow, which acts in particular in the direction (R) of extension, above or along the photovoltaic system.

### BACKGROUND OF THE INVENTION

The present invention relates to a photovoltaic system and the use of a carrier element for the production of a photovoltaic system.

From the prior art, photovoltaic systems are known, in which a plurality of photovoltaic modules are connected with one another by carrier elements in the form of special frames, are assembled in an assembly plane or respectively mounting surface and are aligned at an angle thereto, in order to achieve an optimized solar irradiation per unit area.

In the assembly of the known systems, the photovoltaic modules are applied respectively onto the frames, which support the photovoltaic modules with respect to an assembly or respectively mounting plane. In particular, photovoltaic modules are placed onto frames in the form of a triangular construction, wherein the photovoltaic modules lie respectively on a support arm aligned at an angle to the mounting surface and wherein the support arm supports the photovoltaic module at any height, i.e. at any distance from the assembly plane. Here, the support arm carries the photovoltaic module, supports it at any height and, together with the further arms, receives forces in longitudinal direction which act on the system.

For connecting a plurality of photovoltaic modules in a plurality of rows to a planar photovoltaic system, the respective rows are connected via connecting parts. For example, the respective carrier elements are mounted on continuous rails. On the one hand, this secures the relative position of the photovoltaic modules with respect to one another, and also the position of the photovoltaic system with respect to or respectively in the assembly plane.

The known frames have the disadvantage that they are formed by special shaped parts, in particular as aluminium pressed parts, whereby a production of these shaped parts is material-intensive and laborious. In addition, the frame, as basis of the assembly, must first be constructed in a complicated manner.

It is an object of the present invention to indicate a photovoltaic system which does not have the previously described disadvantages, which is distinguished by assembly parts which are simple to produce and by a simple assembly.

### SUMMARY OF THE INVENTION

This problem is solved by a system having the features of the independent product claims and the use of a carrier element having the features of the independent use claim. Advantageous further developments of the invention are indicated in the subclaims. All combinations of at least two features disclosed in the description, the claims and/or the figures fall within the scope of the invention.

In an advantageous and surprising manner according to the invention, through the photovoltaic system according to the invention structural simplicity and mechanical stability, combined with the best possible bearing- and supporting behaviour on the underlying assembly plane are typically realized by a roof surface, a base or other, typically planar surfaces suitable for placing or respectively laying the photovoltaic system according to the invention; an anchoring or fastening is not necessarily provided.

To improve a support of the photovoltaic system on the underlying assembly plane or respectively for producing an (additional) contact pressure, provision is made within the scope of the invention to provide the supporting means with air- or respectively wind conducting means, for instance in the form of a suitable angle- or profile plate extending transversely to the direction of extension; through this step, turbulences or respectively jet effects are then produced in the case of air flowing above along the assembled photovoltaic system, which generates a vacuum in the intermediate space between the photovoltaic modules and the assembly plane. This vacuum, in turn, provides for an (additional) contact pressure of the device on the assembly plane, with the advantageous effect that—dependent on flow and therefore dependent on wind—additional contact pressure occurs, in which the requirements for weighting or suchlike fastening- or weight elements can be reduced. An advantageous effect of this is then, in turn, a lower constant loading of the underlying roof surface as assembly plane; only in the case of a drop in flow would the additional contact pressure then occur in the manner claimed according to further development through the vacuum.

Through the fact that the photovoltaic module in the preferred photovoltaic system according to the invention in a portion between the first and second engaging means the mechanical or respectively bearing connection takes place exclusively via a frame portion of the photovoltaic module, i.e. the photovoltaic module is not supported in this portion by supporting means at the same height and the photovoltaic module therefore itself contributes to the static bearing capacity of the construction, i.e. is of the self-supporting type, a particularly advantageous structure is produced.

Material is saved, because elements of the supporting means or other further components which are intended for these force absorptions, can be dispensed with.

Through the omission of the further mechanical connection in longitudinal direction between the first and the second engaging means via elements which are not part of the photovoltaic module, a particular flexibility of the system is also produced, because the photovoltaic modules are not forced into a rigid system which is overdetermined in longitudinal direction by the photovoltaic module and the further element. For example, such an overdetermination in longitudinal direction can lead to damage of the photovoltaic modules, if through different elongation of the further element and of the photovoltaic module the photovoltaic module is deformed by the further element.

Preferably, the supporting means comprise at least one single-piece carrier element, which engages on two photovoltaic modules respectively on the edge side and supports the photovoltaic modules. By being in a single piece, a particularly simple assembly is made possible. A plurality of parts do not have to be assembled laboriously, in order to enable an assembly of the photovoltaic modules. Rather, the system can be brought directly in position by simple applying (or respectively engaging) of the (photovoltaic) modules onto the carrier means. If applicable, the modules can be fixed by suitable fixing means, in particular screwing- and/or clamping means, on the carrier means; it is essential, however, that a single-piece connection through the carrier means exists between the modules.

Preferably the profile carrier can be produced by canting or respectively bending a flat pretreated metal, for example aluminium, or metal alloy. These can be produced in a simple manner by conventional processing machines of specialist metal companies, wherein the starting material is also widely-used. A laborious, possibly central production, in particular by specialized production machines for special profiles, is therefore not necessary. Overall, this therefore results in advantages in the costs both of manufacture and logistics.

Further preferably, the profile carrier engages on the respective photovoltaic modules by the engaging surface. The engaging surfaces preferably extend at an angle of 0° and 60°, preferably between 5° and 45°, particularly preferably between 10° and 30°, to the assembly plane or respectively mounting surface.

In order to be able to apply the profile carrier onto the assembly plane, the profile carrier preferably has an intermediate portion which has an assembly plane contact surface extending in the assembly plane and further preferably connects the first and the second engaging means mechanically (i.e. in a force-transmitting manner).

Particularly advantageously, a photovoltaic system can be formed with a plurality of preferably single-piece profile carriers in a particularly simple manner. Here, it is not necessary (as in the prior art) to firstly construct a frame construction from a plurality of parts in a complicated manner. With single-piece profile carriers, which lie or respectively engage both on a first and also a second photovoltaic module, a photovoltaic system can be assembled in a particularly simple manner. The assembly takes place here firstly by applying the engaging means onto the respective photovoltaic modules. If required, the photovoltaic modules can subsequently be fixed, for example by clamping- and/or screwing means, and/or the carrier elements can also be fixed on or in the assembly plane, for example by weight elements and/or clamping- and/or screwing means.

Hereby, in an advantageous manner, a photovoltaic system can be assembled, in particular in which photovoltaic modules are arranged in several rows in the direction of extension and in one row likewise several photovoltaic modules are arranged.

In order to provide simply several photovoltaic modules in a row, it has been found to be advantageous that one of the single-piece carrier elements engages on the first and/or second engaging means respectively onto two photovoltaic modules. Hereby, on the one hand, the relative position of these photovoltaic modules to one another is ensured, in addition the number of necessary carrier elements is reduced, which, in addition to facilitating assembly, also reduces the logistics expenditure.

Through the angled arrangement with respect to the assembly plane, depending on the position of the sun, one of the photovoltaic modules of the photovoltaic system can cast a shadow onto an adjacent other of the photovoltaic modules. In order to counteract this, it has been found to be advantageous to construct the intermediate portion so that it prevents or at least reduces such a casting of a shadow onto another photovoltaic module by a sufficient spacing of the photovoltaic modules. In particular, it has been found to be advantageous that the intermediate portion corresponds to at least one, preferably 1.5 to 3.5 times, more preferably 2 to 3 times the height of the higher of the engaging surfaces (i.e. the maximum distance of the two engaging surfaces from the assembly plane). These values offer a particularly advantageous compromise of surface utilization with photovoltaic modules through close arrangement and minimizing the casting of shadow.

In order to secure the position of the photovoltaic system in the assembly plane, fastening means can be provided on the supporting means, in particular on the intermediate portion of the single-piece carrier element. The fastening means can ensure a form-fit and/or a force-fit between the photovoltaic system and the assembly plane.

In particular, weight- or respectively weighting elements are suitable as fastening means, which in particular press the intermediate portion of the supporting means against the assembly plane. Such weight elements are distinguished by their being simple to install and simple to produce. In addition, they are able to be used independently of the condition of the assembly plane, in particular do not require any mating threads and/or driving-in layers for nails and/or screws. However, these can of course be additionally or alternatively used as fastening means according to requirements and suitability.

Furthermore, protection is claimed for a use according to the invention of a carrier element having the features of the independent use claim. This enables in a particularly advantageous manner a structure of a photovoltaic system in which the photovoltaic modules are of self-supporting type, i.e. themselves contribute to the static bearing capacity of the construction. To avoid repetitions, features of the carrier element disclosed in the context of the photovoltaic module are to apply likewise as disclosed for the use of a carrier element.

Particularly advantageously, the first engaging means have a greater distance from the assembly plane than the second engaging means and are therefore higher than these. Hereby, it is enabled to connect a plurality of photovoltaic modules by carrier element of a single type of construction, wherein in the direction of extension high and low engaging surfaces follow one another alternately, which represents a desired alignment in particular in the case of an alignment to the equator (i.e. for example on the northern hemisphere to a south side).

In order to reliably support the photovoltaic modules also in the case of great loads, for example in the case of a to be expected intensive snow load on the surface, further supporting means, in particular in the form of a supporting foot, can come into use, which support the respective photovoltaic modules in sections in the connecting portion. For this, these further supporting means engage both on the connecting portion of the photovoltaic module and also on the assembly plane and form a (further) bearing connection between these. Nevertheless, the photovoltaic module remains in the connecting portion outside the engaging region of the further supporting means in a self-supporting manner.

In particular in order to counteract an undesired uncovering by strong wind, covering means can be provided, which influence the (wind) flow resistance of the photovoltaic system so that forces which act perpendicularly to the assembly plane and act away from the assembly plane are minimized.

### BRIEF DESCRIPTION OF THE DRAWINGS

Further advantages, features and details of the invention will emerge from the following description of preferred example embodiments and with the aid of the drawings, in which the same elements or elements with the same function are marked by the same reference numbers. These show in:

FIG. 1 a diagrammatic illustration of a first example embodiment of a carrier element for the production of a photovoltaic system in a perspective view,

FIG. 2 a diagrammatic illustration of four of the carrier elements according to FIG. 1 with a photovoltaic module and a wind shield in a perspective view,

FIG. 3 FIG. 2 in a lateral sectional view,

FIG. 4 a photovoltaic system with a plurality of photovoltaic modules, which are connected via carrier elements according to FIG. 1 in a perspective view,

FIG. 5 FIG. 4 in a top view,

FIG. 6 a second example embodiment of a carrier element in a perspective view,

FIG. 7 the carrier element of FIG. 6 with fixing means,

FIG. 8 a system with a second example embodiment of a carrier element and with a third example embodiment of a carrier element shown in part,

FIG. 9 the system of FIG. 8 with two applied photovoltaic modules in a side view,

FIG. 10 FIG. 9 in a perspective view,

FIG. 11 a photovoltaic system with a plurality of photovoltaic modules and carrier elements according to FIG. 8;

FIG. 12 to FIG. 15: different views of a preferred embodiment of the invention for generating a contact pressure of the photovoltaic device on an underlying assembly surface in the case of an air- or respectively wind flow by means of a transversely running slot and guide means associated therewith in the form of a guide plate for bringing about a flow jet effect; and

FIG. 16 a diagrammatic side view of a further variant of the solution according to FIGS. 12 to 15.

### DETAILED DESCRIPTION

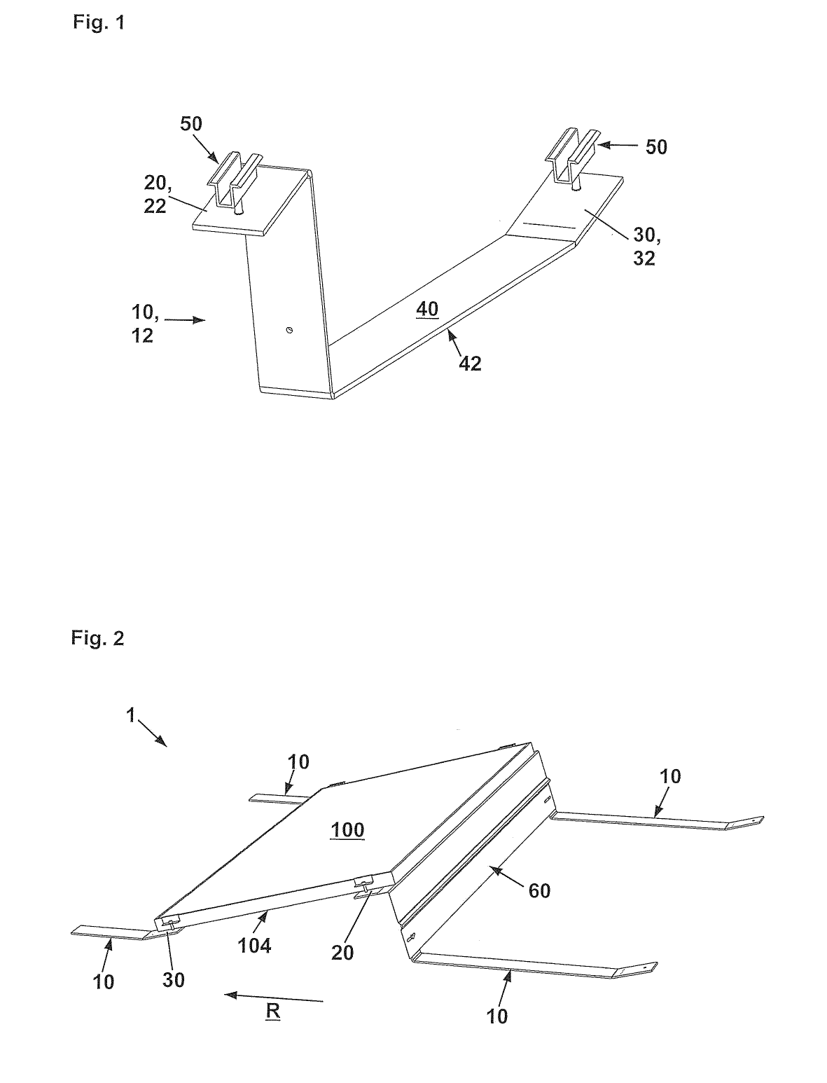

FIG. 1 shows a first example embodiment of supporting means 10 with a carrier element 12 for supporting a photovoltaic module in a photovoltaic system. It comprises first engaging means 20 with a first engaging surface 22 for direct applying onto a frame section of a photovoltaic module, second engaging means 30 with a second engaging surface 32, an intermediate portion 40 with an assembly plane contact surface 42, which lies against the assembly plane. On the engaging means respectively fixing means 50 are provided in the form of clamping means for fixing the photovoltaic modules with respect to the supporting means 10.

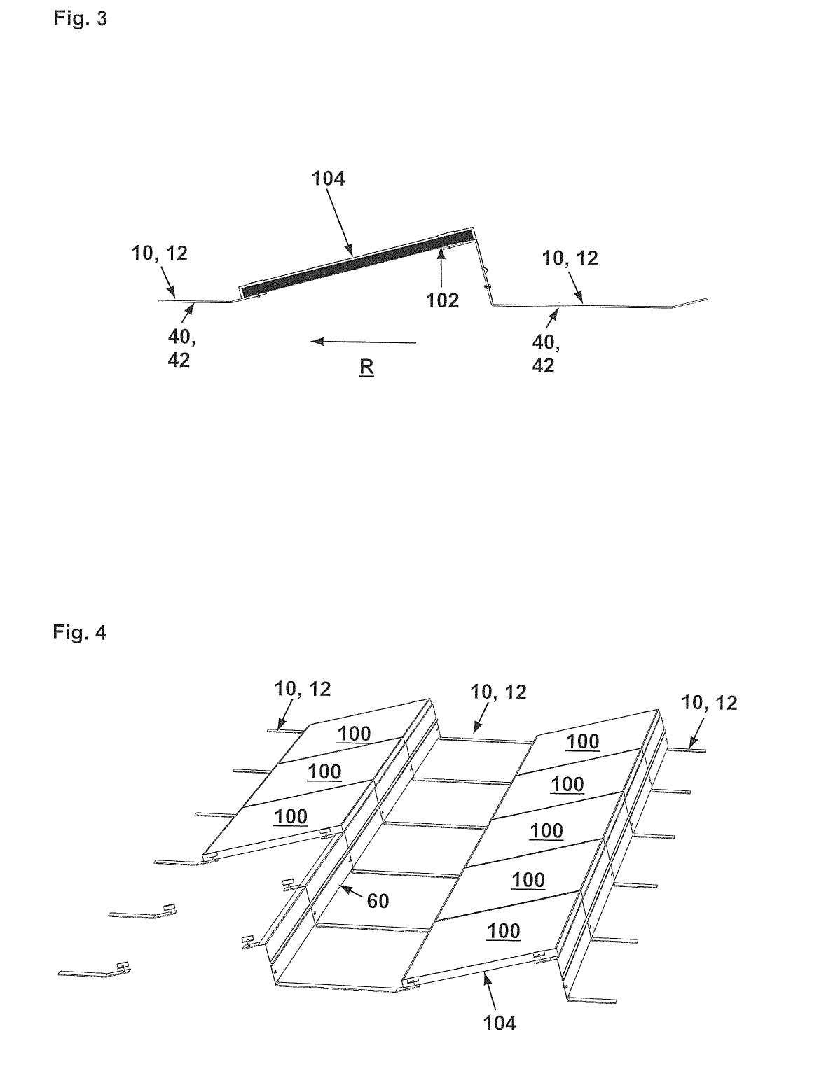

FIG. 2 shows a photovoltaic system 1 with a photovoltaic module 100 and supporting means 10, comprising four of the carrier elements 12 shown in FIG. 1, in a perspective view. FIG. 3 shows this in a cross-section. The first engaging means 20, the photovoltaic module 100, and the second engaging means 30 are arranged one behind the other in direction R of extension. On an upper edge, i.e. on a portion associated with the engaging means of the carrier elements 12 at a greater distance from the assembly plane, covering means 60 in the form of a wind plate are provided, which alter the flow behaviour so that a force acting perpendicularly to the assembly plane, which would lead to a removing of the photovoltaic module 100 from the assembly plane, is reduced.

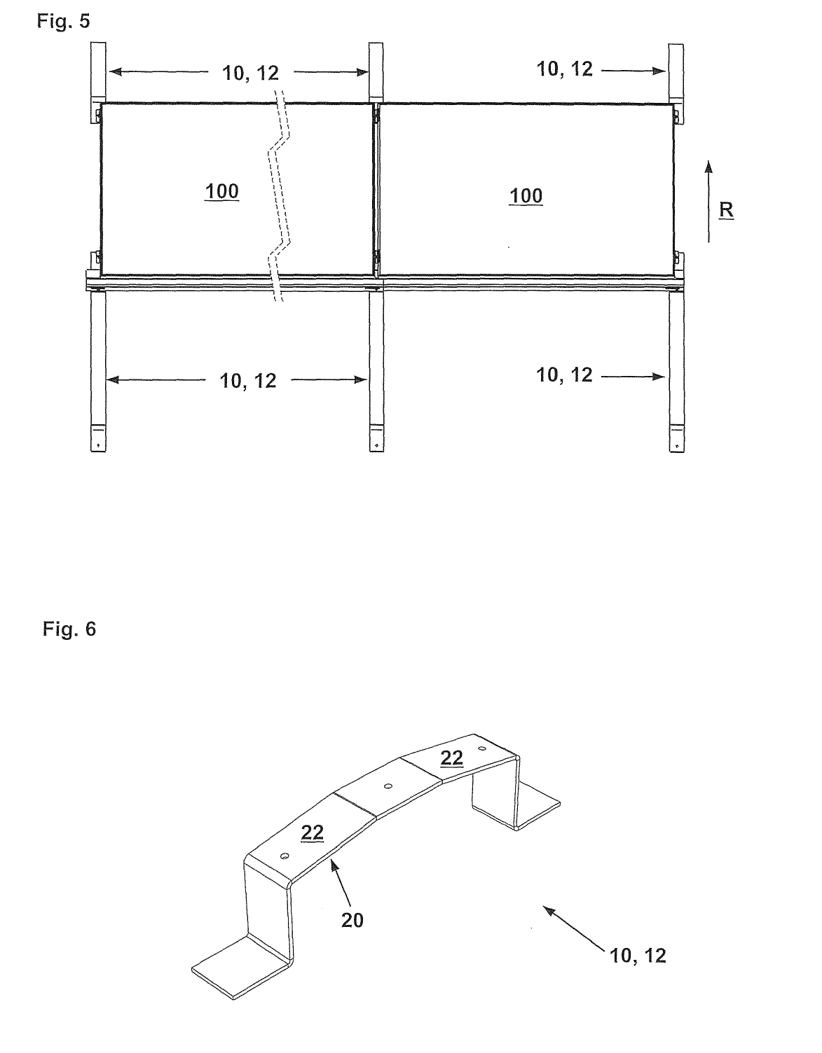

In FIG. 4 a plurality of photovoltaic modules 100 is shown in a perspective view, which are connected to an overall system via a plurality of carrier elements 12. FIG. 5 shows a cut-out of this system in a diagrammatic top view. In a frame portion 102 the photovoltaic module 100 is of self-supporting type, i.e. contributes to the bearing capacity of the overall system.

For the assembly of the photovoltaic system, firstly a plurality of carrier elements 12 are brought into position in the assembly plane. Then, photovoltaic modules are applied onto the carrier elements 12 so that they lie in the direction R of extension on the two sides, i.e. on both sides, respectively on the engaging surfaces of two carrier elements 12. To secure the position relative to the carrier elements 12, the photovoltaic modules are fixed on the engaging means 20 or respectively 30 by fixing means 50 in the form of clamping means. Hereby, in addition the position of the carrier elements 12 to one another is indirectly established.

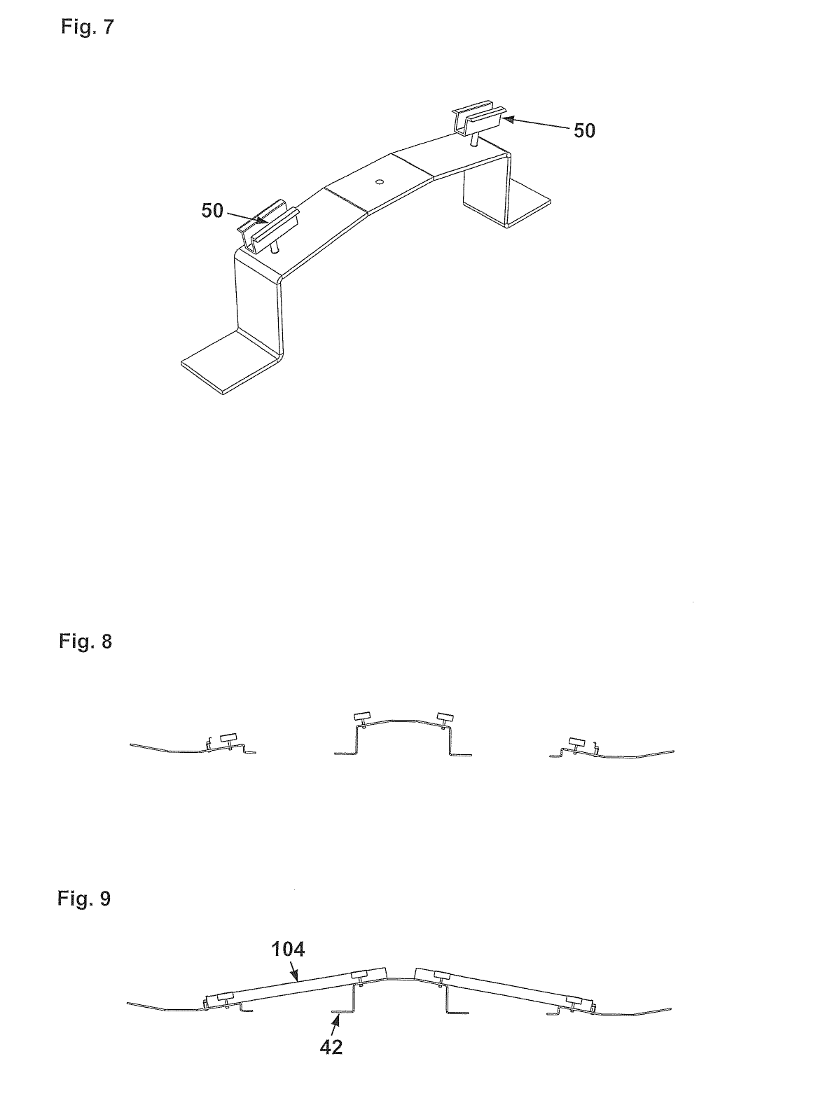

FIG. 6 and FIG. 7 show a further example embodiment of supporting means 10 with a carrier element 12 for supporting a photovoltaic module in a photovoltaic system, wherein in FIG. 7 additional fixing means in the form of clamping means are also illustrated for fixing the photovoltaic modules 100 on the supporting means 10. The supporting means 10 have on both sides first engaging means 20 with an engaging surface 22 for the applying of photovoltaic modules.

As shown in FIG. 8, in this example embodiment the supporting means 10 for the supporting of photovoltaic modules comprise further carrier elements 14. For the assembly of the photovoltaic system, firstly several of the carrier elements 12 and of the further carrier elements 14 are brought into position in the assembly plane. Photovoltaic modules 100 are then applied onto the carrier elements 12 so that they lie in the direction of extension on one side on the engaging surfaces of two of the carrier elements 12 and lie on the other side on the engaging surfaces of two of the further carrier elements 14. To secure the position relative to the carrier elements 12 and the further carrier elements 14, the photovoltaic elements are fixed by clamping means on the engaging means 20 or respectively 30. Hereby, in addition, the position of the carrier elements 12 and of the further carrier elements 14 with respect to one another is indirectly established.

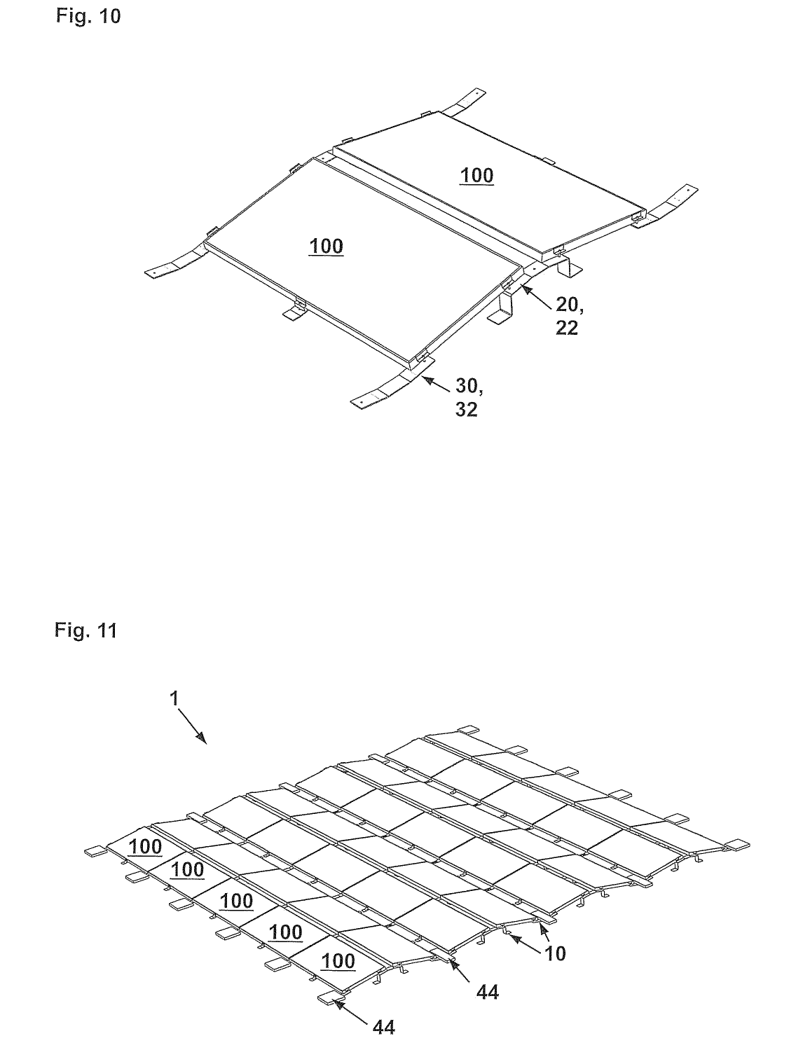

In FIG. 9 and FIG. 10 in this manner a plurality of photovoltaic modules 100 are assembled to a photovoltaic system by supporting means 10.

FIG. 11 shows a plurality of photovoltaic modules 100, which are arranged by the supporting means 10 in several rows as a photovoltaic system. On the further carrier elements 14 there are fastening means in the form of weight elements 44 engaging over the carrier elements 14, which secure the position and the cohesion of the photovoltaic system in the assembly plane, without this having to be fixed in a laborious manner on or in the assembly plane by screws or suchlike.

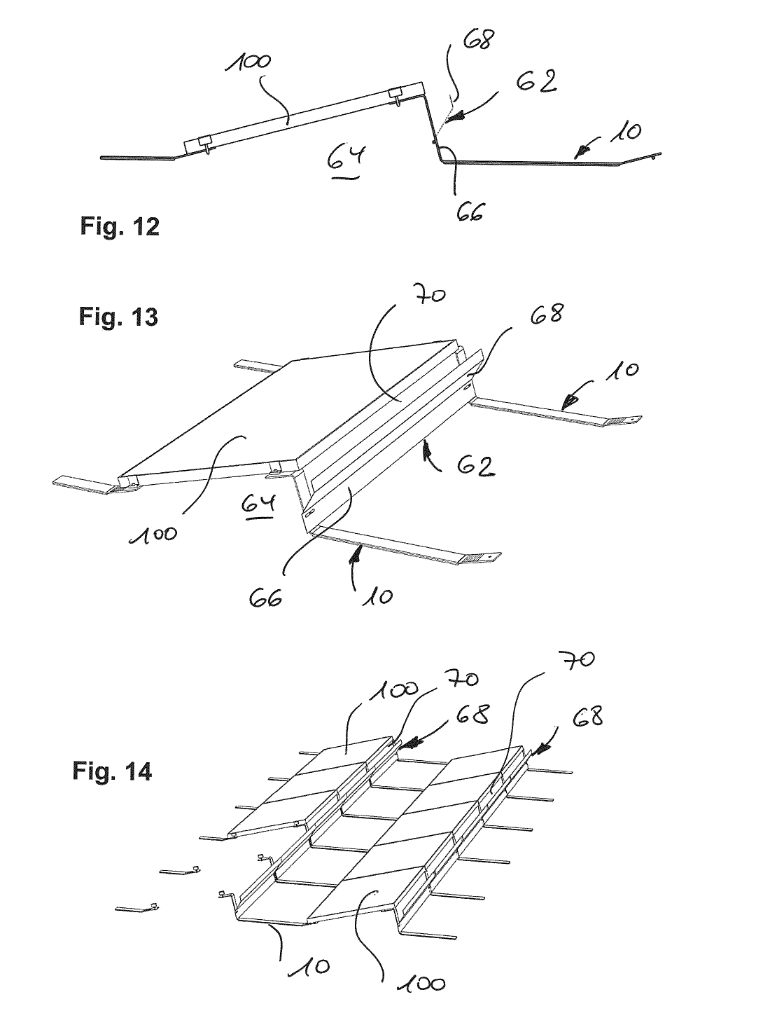

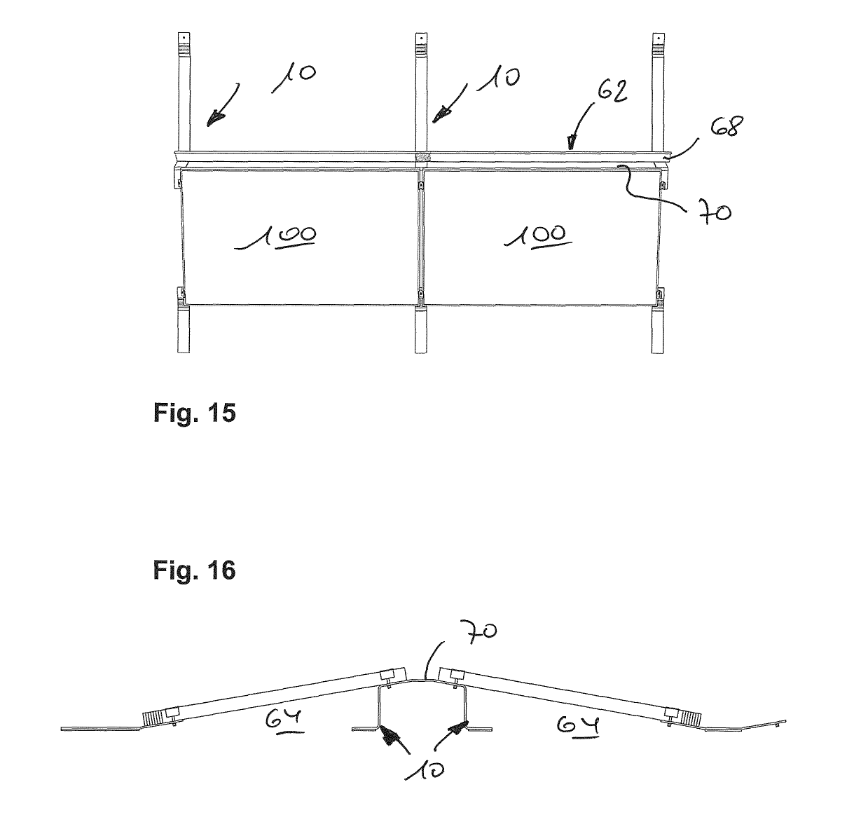

FIGS. 12 and 15 show a first variant of the invention as preferred example embodiment. In the example embodiment of FIGS. 12 to 15 (otherwise in an analogous manner to the previously described illustrations and descriptions) an additional guide plate, in the form of an angle plate 62, extending perpendicularly to the direction of extension (i.e. vertically to the plane of the figure) is associated with the purpose of producing an additional contact pressure of the shown device in the direction of the underlying assembly plane in the case of wind or respectively air flow, in particular along the direction of extension (i.e. in horizontal direction with regard to the planes of the figure of FIGS. 12 to 15). This angle plate 62 produces a flow slot or respectively a flow jet between an upper free edge of a photovoltaic module 100 and the upper free edge of the plate 62, with the effect that the air flowing past then brings about a vacuum in the intermediate space 64 towards the base (wherein then for instance the previously described covering means (covering plates) 60 have suitable apertures or respectively openings at respectively provided sites, alternatively also can be dispensed with). Again alternatively, respectively only practically local plates, which do not extend continuously longitudinally, could be associated with such holes or respectively apertures, not shown in the figures, in available covering plates 60 (for instance FIG. 2).

The detail views of FIGS. 12 to 15 illustrate the practical structural configuration, in particular of the guide plate 62; in the illustrated continuous case, this is an angle plate which is double-angled or respectively cranked in cross-section, which exposes a slot for instance in the manner shown in the profile view of FIG. 12. In this respect, this solution modifies the completely closed covering plate 60 (for instance shown in FIG. 2), in which carrier contact only exists in a lower or respectively base-side region 66 of the covering plate 62, whilst an angled (offset) region 68 of the angle plate forms a distance from the carrier structure 10, as a transverse slot 70 in the manner shown for instance in FIG. 13.

In an otherwise known manner, an air flow above or respectively along the module 10 or respectively the module arrangement (FIG. 14) leads to a jet- or respectively vacuum effect in the intermediate space 64, with the effect that the overall arrangement is pressed in the previously described manner onto the underlying (and not shown in further detail in the Figs.) base. In addition to the perspective view of a (partially) assembled system according to FIG. 14, the top view of FIG. 15 illustrates further structural details or respectively the geometric conditions of the described example embodiment.

An analogous idea applies for the further embodiment of FIG. 15. Here, the supporting means 10 would in fact be able to have a continuous facing, in a manner not shown in further detail, which, however, then have corresponding apertures or respectively holes the purpose of producing jets. Here, also, the positive effect is the production of a vacuum in the intermediate spaces 64 to the (not shown) underlying assembly surface.

The present invention enables as a whole a particularly simple assembly, not liable to error, of a photovoltaic system, wherein the individual parts necessary for the assembly can be produced in a surprisingly simple and material-saving manner.

1. A photovoltaic system (1) comprising two photovoltaic modules (100) and supporting means (10) for supporting and/or retaining each photovoltaic module (100) in a position relative to an assembly plane, said position forming an inclination angle, wherein the supporting means (10) comprises first and second engaging means (20 or respectively 30) for each of the photovoltaic modules (100), each said engaging means engaging onto a frame portion (102) of the corresponding photovoltaic module (100), wherein the first engaging means (20), the photovoltaic module (100), and the second engaging means (30) are arranged in a successive manner in a direction (R) of extension, wherein the mechanical connection between the first and the second engaging means (20 or respectively 30) in the direction (R) of extension is preferably produced solely by means of a portion (104) of the photovoltaic module (100), in particular a frame portion (102) of the photovoltaic module (100), and wherein the supporting means are paired with air and/or wind conducting means (62) such that a vacuum is generated in an intermediate space formed between at least one of the photovoltaic modules and the underlying assembly plane in the event of an airflow, which acts in particular in the direction (R) of extension, above or along the photovoltaic system.

2. The photovoltaic system according to claim 1, wherein the supporting means (10) comprise at least one single-piece carrier element (12, 14), which forms at one end the first or second engaging means (20 or respectively 30) for a first photovoltaic module (100) and at the other end forms the first or second engaging means (20 or respectively 30) for a second photovoltaic module (100).

3. The photovoltaic system according to claim 2, wherein at least one of the single-piece carrier elements (12, 14), in the portion forming the first or respectively second engaging means (20 or respectively 30) for the first photovoltaic module and/or in the portion forming the first or respectively second engaging means for the second photovoltaic module has a first and/or second engaging surface (22; 32) for engaging onto the photovoltaic module (100), which extends at an angle between 5° and 45°, in an inclination angle of the associated photovoltaic module (100), to the assembly plane.

4. The photovoltaic system according to claim 2, wherein the carrier element (12, 14) has an intermediate portion (40) with an assembly plane contact surface (42) extending in the assembly plane, wherein the intermediate portion (40) has a length which corresponds to 1.5 to 3.5 times the maximum distance of the first and/or second engaging surface (22 or respectively 32) from the assembly plane and the intermediate portion fastening means are provided for fastening the carrier element (12, 14) to the assembly plane.

5. The photovoltaic system according to claim 4, wherein the fastening means comprise an over-engaging weight element.

6. The photovoltaic system according to claim 2, wherein carrier elements (12, 14) are associated on both sides with each photovoltaic module (100), wherein at least one of the carrier elements supports with the first and/or second engaging surface (22 or respectively 32) respectively two adjacent photovoltaic modules (100).

7. The photovoltaic system according to claim 1, wherein the first engaging means (20) have has a greater distance from the assembly plane than the second engaging means (30).

8. The photovoltaic system according to claim 1, wherein the inclination angle is between 5° and 45°.

9. The photovoltaic system according to claim 1, wherein the plurality of photovoltaic modules (100) are arranged in a plurality of rows following one another in the direction (R) of extension by connection through supporting means (10).

10. The photovoltaic system according to claim 1, wherein covering means (60) are provided for influencing wind flow behaviour so that a wind force which would accelerate the photovoltaic modules (100) away from the assembly plane, is minimized.

11. The photovoltaic system according to claim 4, wherein at least one supporting element comprising a supporting foot is provided in the intermediate portion (40) of at least one of the photovoltaic modules (100), and at least partially supports the photovoltaic modules (100) in the intermediate portion (40).

12. The photovoltaic system according to claim 1, wherein fixing means (50) are associated with the first and/or second engaging means (20 or respectively 30), for fixing the photovoltaic modules (100) on the engaging means (20 or respectively 30).

13. A photovoltaic system (1) comprising at least one photovoltaic module (100) and supporting means (10) for supporting and/or retaining each photovoltaic module (100) in a position relative to an assembly plane, said position forming an inclination angle, wherein the supporting means (10) comprises first and second engaging means (20 or respectively 30) for each of the photovoltaic modules (100), each said engaging means engaging onto a frame portion (102) of the corresponding photovoltaic module (100), wherein the first engaging means (20), the photovoltaic module (100), and the second engaging means (30) are arranged in a successive manner in a direction (R) of extension, wherein the mechanical connection between the first and the second engaging means (20 or respectively 30) in the direction (R) of extension is preferably produced solely by means of a portion (104) of the photovoltaic module (100), in particular a frame portion (102) of the photovoltaic module (100).

14. (canceled)

15. (canceled)
